(19) United States
(12) Patent Application Publication
(10) Pub. No.: US 2022/0379814 A1
(43) Pub. Date: Dec. 1, 2022

(54) LADDER RACK ASSEMBLY

(71) Applicant: RANGER DESIGN, Baie d’Urfe (CA)

(72) Inventors: Steve ROUMELIOTIS, Beaconsfield (CA); Surjit SINGH, Brampton (CA); Melody XINIDAKIS, Dorval (CA)

(21) Appl. No.: 17/826,993

(22) Filed: May 27, 2022

Related U.S. Application Data
(60) Provisional application No. 63/194,919, filed on May 28, 2021.

(51) Int. Cl. B60R 9/048; B60R 3/00

(52) U.S. Cl. CPC B60R 9/0485; B60R 3/007

(57) ABSTRACT

A ladder rack assembly for connecting at least one ladder to a vehicle. The ladder rack assembly includes a frame configured to connect to a roof of the vehicle; a first retention hook connected to a first laterally extending frame portion; a second retention hook connected to a second laterally extending frame portion; and an over-center latch connected to a longitudinally extending frame portion, the first retention hook, the second retention hook, and the over-center latch being arranged to secure the at least one ladder to the vehicle. When the at least one ladder is installed on the ladder rack assembly, the retention hooks and the over-center latch are disposed laterally on an exterior of the ladder.

### CROSS-REFERENCE

The present application claims priority to U.S. Provisional Patent Application No. 63/194,919, entitled “Clamping Ladder Rack”, filed on May 28, 2021, the entirety of which is incorporated herein by reference.

### FIELD OF TECHNOLOGY

The present technology relates generally to ladder racks for securing ladders to a vehicle.

### BACKGROUND

Ladder racks are well known for storing ladders on vehicles. Typically, the rack is mounted to the roof of a utility vehicle. The rack has a frame that can be mounted to the top of vehicle. The frame is defined by crossbars and end pieces, the end pieces are commonly referred to as skis. Brackets extend upwardly from each of the crossbars to engage the steps or rungs of the ladder, and some form of retainer or clamp engages the steps to secure the ladder. All connections are done on the steps or rungs.

In use, the ladder is lifted to the top of the vehicle and then positioned so that the brackets on each of the crossbars are positioned between the steps and engage the steps. This can result in several attempts to properly position the ladder. Once positioned, the ladder is then secured to the frame. Some form of retainer is commonly used to secure the ladder to the rack.

Typically, the retainer is a clamp that engages one of the steps or rungs of the ladder. An example of a clamp is a bracket that pivots between a clamped and unclamped position with respect to the ladder step. The bracket is mounted to a handle through a long rod. The bracket rotates when the handle is rotated by a user between the clamped position, where it engages the step and the unclamped position, where the step is released.

The long rod is needed as an extension because the bracket has to engage the step but the locking handle has to be near the user at the side of the vehicle. Again, the ladder must be positioned properly with respect to the bracket so that the bracket can properly engage a step of the ladder.

The problem with these racks is that the brackets have to engage the steps of the ladder. This requires the ladder to be carefully position between the spaced brackets and the locking or securing device. With extension ladders this gets to be even more difficult.

There therefore remains a desire for a ladder rack that makes mounting and securing a ladder easier and faster.

### SUMMARY

It is an object of the present technology to ameliorate at least some of the inconveniences present in the prior art.

According to one aspect of the present technology, there is provided a ladder rack assembly for connecting at least one ladder to a vehicle. The ladder rack assembly includes a frame configured to connect to a roof of the vehicle; a first retention hook connected to a first laterally extending frame portion; a second retention hook connected to a second laterally extending frame portion; and an over-center latch connected to a longitudinally extending frame portion, the first retention hook, the second retention hook, and the over-center latch being arranged to secure the at least one ladder to the vehicle.

In some embodiments, when the at least one ladder is installed on the ladder rack assembly: the first retention hook is disposed laterally inward of the at least one ladder, an upper portion of the first retention hook extending from an exterior of the at least one ladder and over an inward-arranged side of the at least one ladder; the second retention hook is disposed laterally inward of the at least one ladder, an upper portion of the second retention hook extending from the exterior of the at least one ladder and over the inward-arranged side of the at least one ladder; and the over-center latch is disposed laterally outward of the at least one ladder, an upper portion of the over-center latch extending from the exterior of the at least one ladder and over an outward-arranged side of the at least one ladder.

In some embodiments, the frame includes a first ski configured to connect to a first side portion of the roof; a second ski configured to connect to a second side portion of the roof, the second ski being arranged parallel to the first ski; a first cross-member connected to a first end portion of the first ski and a first end portion of the second ski; and a second cross-member connected to a second end portion of the first ski and a second end portion of the second ski, the first end portions of the first ski and the second ski being disposed at ends opposite to the first end portions of the first ski and the second ski, the second cross-member being arranged parallel to the first cross-member, the first and second cross-members being arranged orthogonal to the first and second skis.

In some embodiments, the first laterally extending frame portion includes the first cross-member; the first retention hook is connected to the first cross-member; the second laterally extending frame portion includes the second cross-member; the second retention hook is connected to the second cross-member; the longitudinally extending frame portion includes the first ski; and the over-center latch is connected to the first ski.

In some embodiments, the over-center latch is pivotally connected to the frame; and in an open position, at least a majority of the over-center latch is disposed below the frame.

In some embodiments, the over-center latch is selectively positionable along a longitudinal direction.

In some embodiments, the first retention hook and the second retention hook are slidably connected to the frame; and the first retention hook and the second retention hook are selectively positionable along a lateral direction.

In some embodiments, at least one of the first retention hook and the second retention hook includes a quick release fastener for selectively securing and selectively moving the at least one of the first retention hook and the second retention hook.

In some embodiments, the ladder rack assembly further includes at least one ladder stopper connected to the frame, the ladder stopper being configured to abut the at least one ladder when installed on the ladder rack assembly.

In some embodiments, where the at least one ladder is a first ladder and the ladder rack assembly is configured to connect the first ladder and a second ladder to the vehicle, the over-center latch is a first over-center latch, and the first retention hook, the second retention hook, and the over-center latch are arranged to secure the first ladder to the vehicle. The ladder rack assembly further includes a third retention hook connected to the first cross-member; a fourth retention hook connected to the second cross-member; and a second over-center latch connected to the second ski, the third retention hook, the fourth retention hook, and the second over-center latch being arranged to secure the second ladder to the vehicle.

In some embodiments, the ladder rack assembly further includes a first ladder stopper connected to the frame, the first ladder stopper being configured to abut the first ladder when installed on the ladder rack assembly; and a second ladder stopper connected to the frame, the second ladder stopper being configured to abut the second ladder when installed on the ladder rack assembly.

In some embodiments, the first ski is formed from two first selectively connected elongate members; and the second ski is formed from two second selectively connected elongate members.

Embodiments of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of embodiments of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a perspective view of a clamping ladder rack according to non-limiting embodiments of the present technology;

FIG. 2 is a partial, perspective view of the clamping ladder rack of FIG. 1, with a ladder installed thereon;

FIG. 3 is a perspective view of a first configuration of a retention hook of the clamping ladder rack of FIG. 1;

FIG. 4 is a perspective view of a second configuration of a retention hook of the clamping ladder rack of FIG. 1;

FIG. 5 is an exploded view of the retention hook of FIG. 4;

FIG. 6 is a partial, perspective view of the clamping ladder rack of FIG. 1, with a ladder stopper connected thereto;

FIG. 7 in a partial, exploded view of portions of the clamping ladder rack of FIG. 1;

FIG. 8 is a perspective view of an over-center latch of the clamping ladder rack of FIG. 1, shown as installed and in isolation;

FIGS. 9A and 9B are images illustrating installation of the over-center latch of FIG. 8;

FIG. 10 is a perspective view of the over-center latch of FIG. 8, arranged in a closed position;

FIGS. 11A and 11B are perspective views of the over-center latch of FIG. 8, arranged in an open position; and

FIG. 12 is a partial, perspective view of a two-part ski of the clamping ladder rack of FIG. 1, with two portions of the two-part ski being shown separated.

It should be noted that, unless otherwise explicitly specified herein, the drawings are not necessarily to scale.

### DETAILED DESCRIPTION

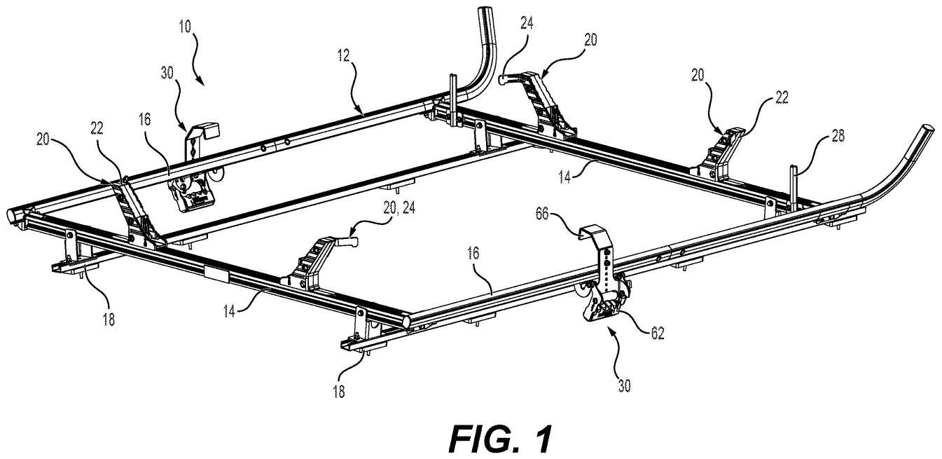

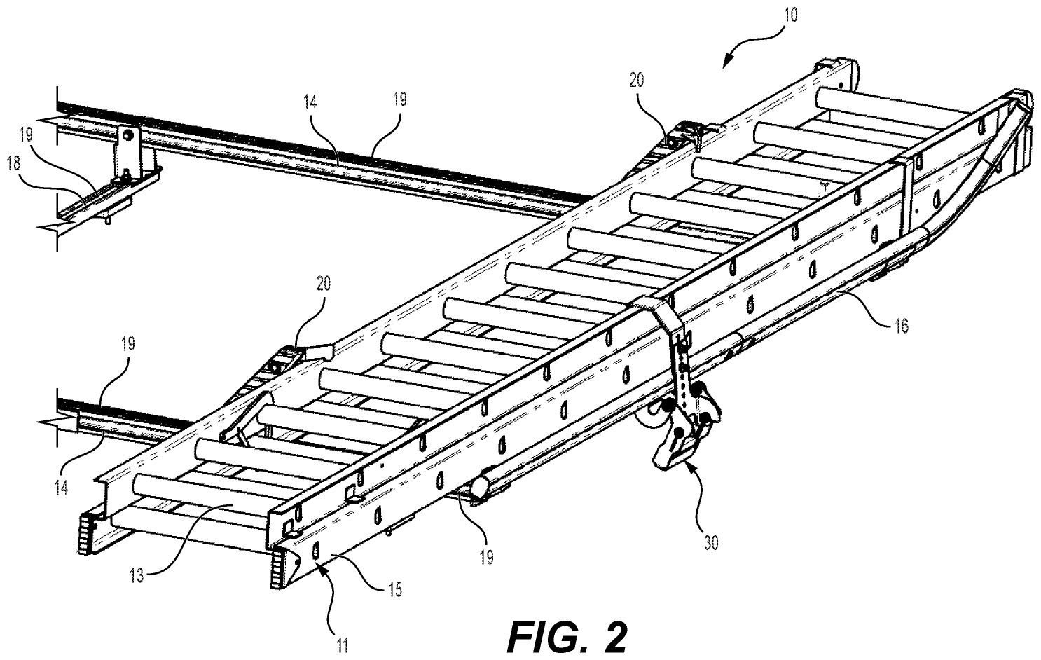

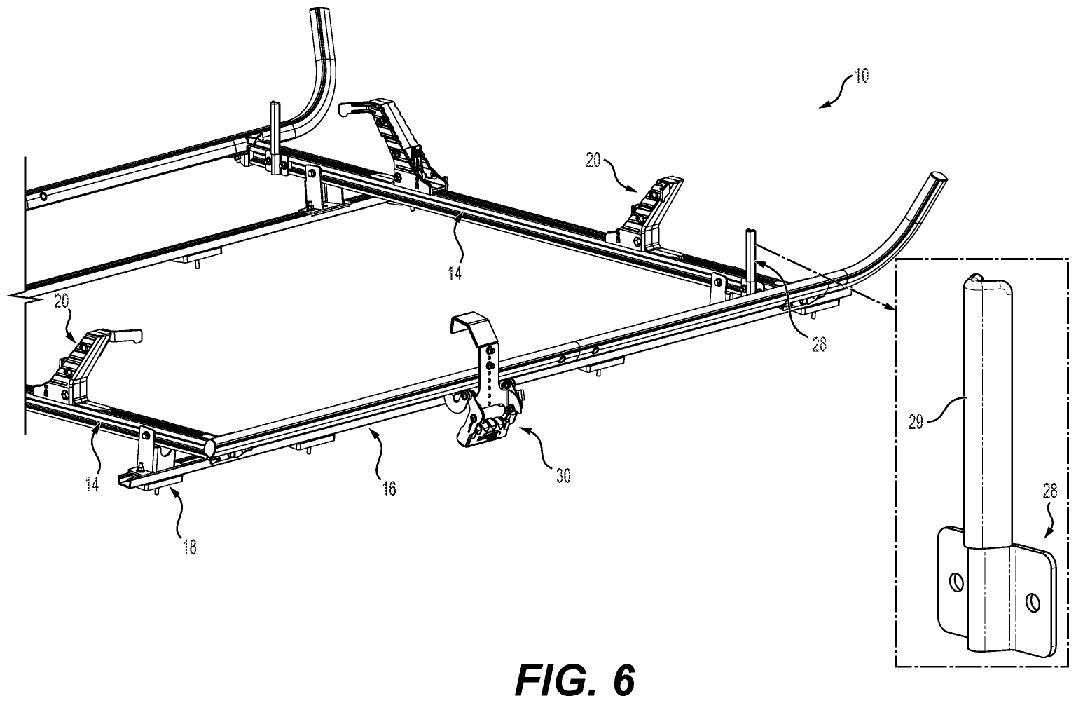

With reference to FIGS. 1 through 10 and in particular FIGS. 1 and 2, the ladder rack 10 of the present technology is generally shown. The ladder rack 10 has a frame 12 defined by cross-members 14 and end sections 16, also referred to as two-part skis 16. Vehicle mounting tracks 18 are provided to attach the frame to the top of a vehicle.

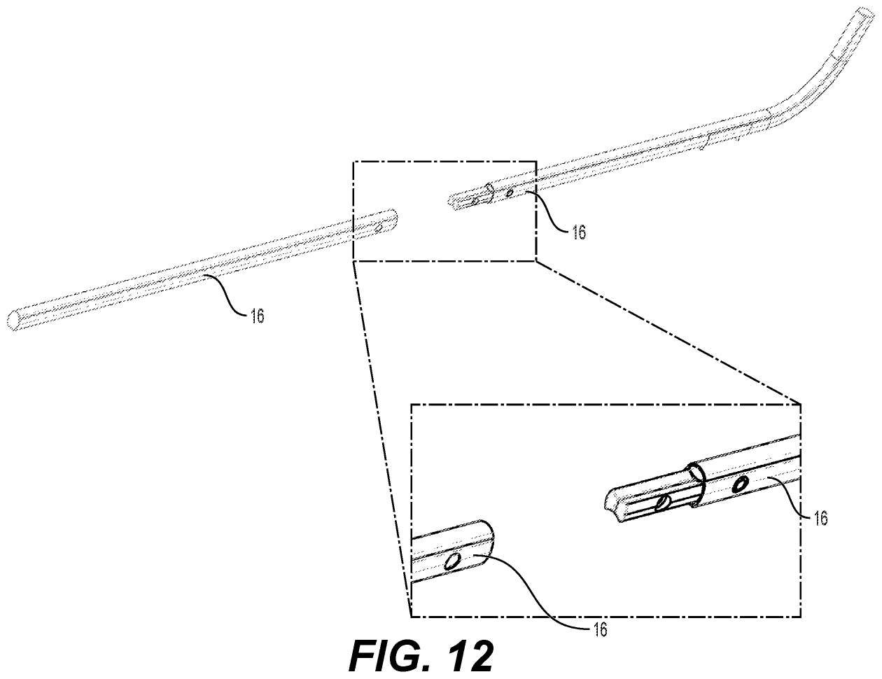

As illustrated in more detail in FIG. 12, the skis 16 are disclosed as being in two parts that can be easily assembled. This design allows smaller shipping packages and easier storage.

With reference to FIGS. 1 and 2, the cross-members 14, skis 16 and vehicle tracks 18 all have mounting channels 19 that allow for infinite positioning along the skis, vehicle tracks and crossmembers to accommodate ladders of all sizes. As will be described further below, retention hooks 20 are positionable along the cross-members 14 to accommodate ladders of many different widths. Positioning of the cross-members 14 along the skis 16 and the tracks 18 similarly provide a plurality of attachment positions to accommodate ladders of many different lengths.

It should be appreciated that this description is to a two-ladder rack, but those of ordinary skill in the art will appreciate that a one ladder rack could also be used. With the one ladder rack, the frame 12 could have two cross members 14 and a single ski 16. Obviously, a single ladder could be mounted on a two-ladder rack 10 if desired.

Retention hooks 20 extend from the cross-members 14 to engage the side rail of the ladder 11. This greatly simplifies the positioning of the ladder on the rack since the need to properly insert the retainers between the steps of the ladder 11 is no longer necessary. By having positioning anywhere along the cross-members 14, use of the retention hooks 20 further simplifies insertion of the ladder 11 in the rack assembly 10. Placement of the hooks 20 can therefore be chosen in order to conform to any width of an embodiment of the ladder 11.

A ladder stopper 28 is provided in the illustrated embodiment to impede longitudinal movement of the ladder on the rack 12. An upper portion 29 of the ladder stopper 28 is vinyl dipped in at least some embodiments to reduce damage to the ladder 11 when installed. The ladder 11 is secured by an over-center latch 30 that also engages the side rail, not the ladder steps. This generally simplifies securing the ladder 11 to the vehicle. The latch hook 66 of the over-center latch is positioned over the ladder side rail members 15 and the handle 62 is pressed down to secure the ladder 11.

In use, the rack 10 is mounted to a vehicle (not shown). In the disclosed environment, the rack 10 is a two-ladder rack. It is contemplated that the rack 10 could be configured to carry only one ladder. When mounted to the roof of a vehicle, the skis 16 of the rack are adjacent the sides of the vehicle for easy access by the user. To store the ladder, the side rails 15 of the ladder are positioned against the retention hooks 20, and in the disclosed embodiment against the first and second hooks 22, 24. The retention hooks 20 retain the ladder both laterally and vertically. The ladder stopper 28 retains the ladder longitudinally, i.e. along a forward-rearward axis.

The over center latch 30 clamps down on the ladder 11 to lock it in place both laterally and vertically. The retention hooks 20 and over-center latch 30 engage the side rails 15 of the ladder 11 avoiding the need to engage the ladder steps 13. By securing the ladder 11 from an exterior of the ladder 11, different types of ladders can be secured by the rack 10, including those with various structures between the ladder steps or with various ladder step spacing.

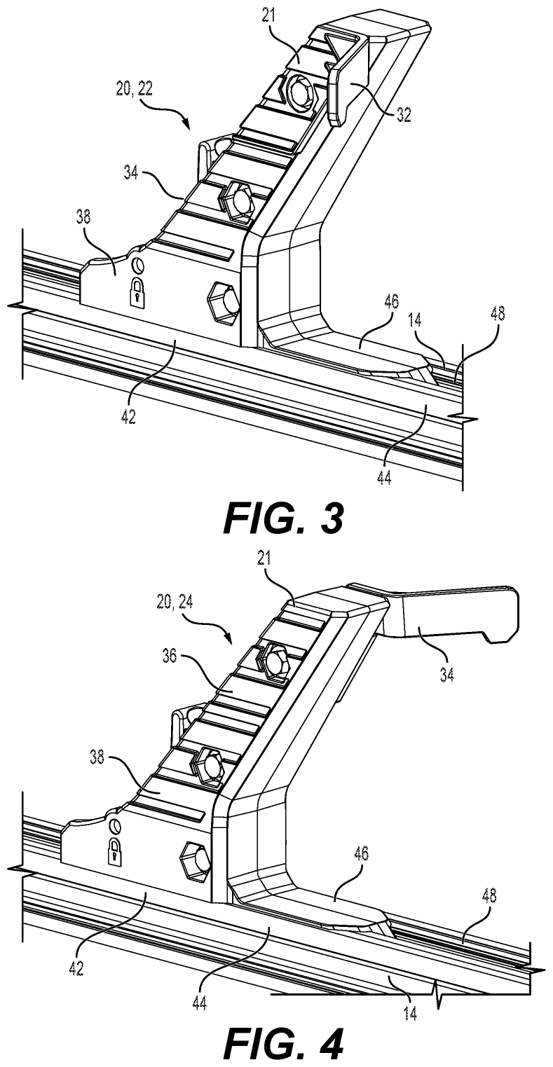

With reference to FIGS. 3 to 5, the retention hooks 20 of the disclosed embodiment will be described. It should be understood buy those of ordinary skill in the art that the disclosed hooks 20 are representative and other hooks of various designs could be used.

The hooks 20 for each ladder have a first hook 22 and a second hook 24. The hooks 22 and 24 are the same with the exception of the distal ends 21. The distal end 21 of hook 22 has a curved finger 32 and hook 24 has a longer arm and curved finger 34. The curved fingers 32 and 34 face each other as disclosed. The side rails 15 of ladder 11 is positioned under the hook 24 and arm 34. To mount the ladder 11, the ladder 11 is positioned on the crossmember 14 at an angle with one side rail 15 higher than the other side rail 15 so that the inner side rail 15 can slide under the hook and arm 32 and 34. By slightly angling the ladder 11, it can be quickly and easily positioned under the hooks 20.

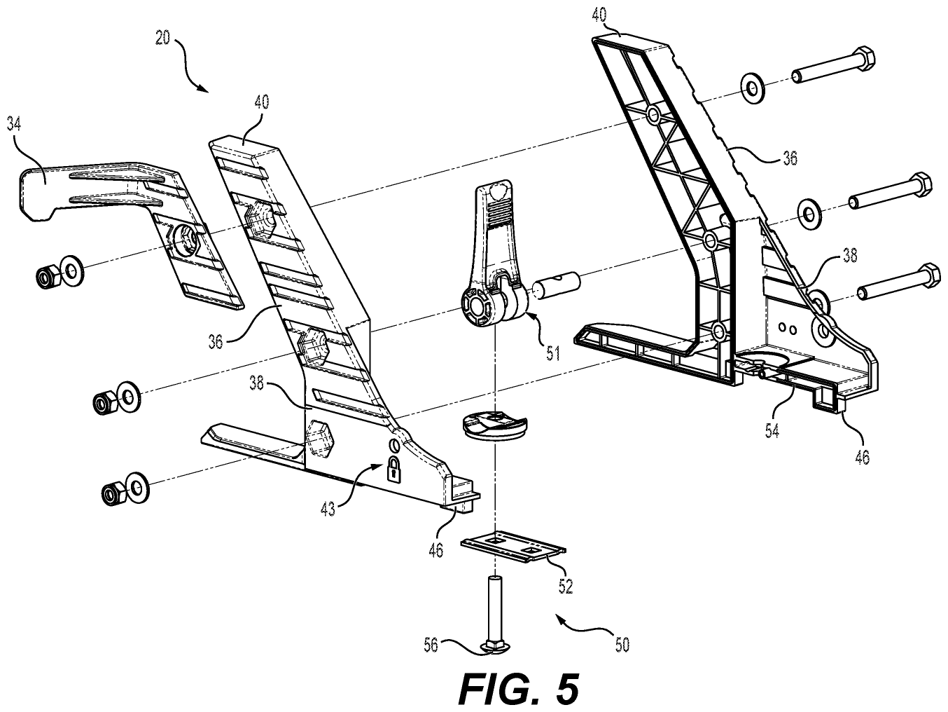

The hooks 20 have the same bodies 36 and bases 38. With reference to FIG. 5, the hooks 20 of the disclosed embodiment are formed in two halves 40. The halves 40 can be bolted together and then one of the two distal ends 32 or 34 bolted onto the body 36. A guide 46 is inserted into a top channel 48 in the crossmember 14. The guide 46 allows for infinite positioning of the hooks 20 along the crossmember 14 to accommodate ladders 11 of various sizes. A fastener 50 is disposed between the two halves 40 of the hook 20. The fastener 50 locks the hooks 20 at the desired location. In the disclosed embodiment fasteners 20 include a plate 52 that is received in a pocket 54 and a bolt and nut 56 extends through the plate 52 to lock the hook 20 in position. In at least some embodiments, the fastener 50 includes a quick release 51 to aid in providing easy lateral positioning adjustment of the hooks 20. The hooks 20 also have defined therein a hole 43 to receive a padlock (not shown) in order to secure the ladder in place when in use.

The body 36 of each hook 20 is angled in the XY and Z axis to accommodate ladders 11 of various heights. As disclosed, the body 36 of each hook 20 is angled at about 45 degrees in the XY plane and about 25° in the YZ plane.

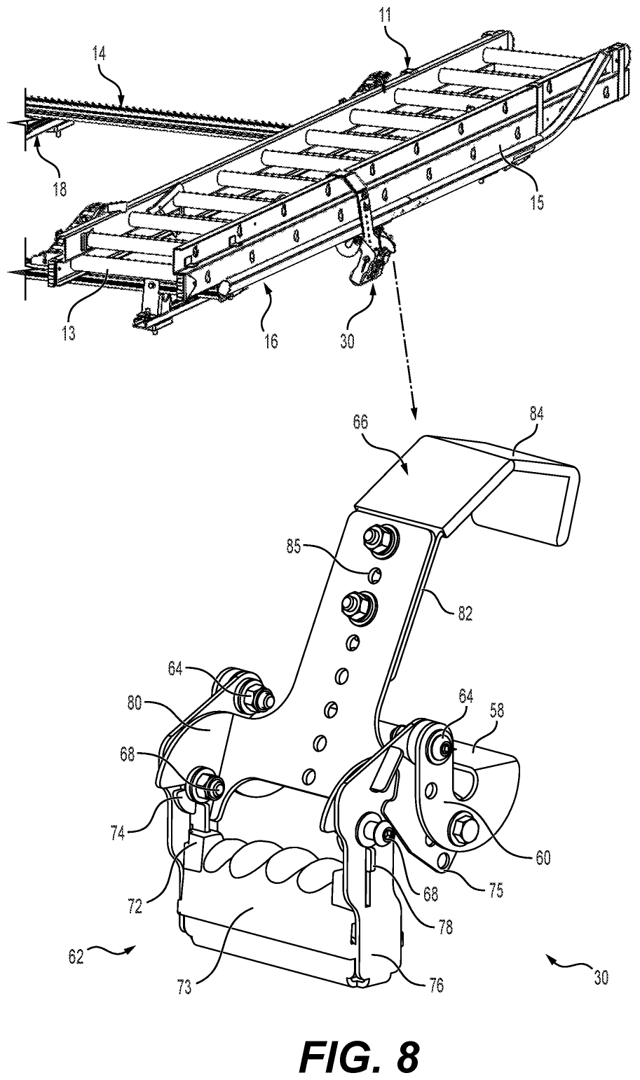

With reference to FIGS. 8 to 10, the over-center latch 30 is described in more detail. The over-center latch 30 is mounted by fasteners (not shown) to the skis 16. The over-center latch position is infinitely adjustable along skis 16 to avoid interference with the steps 13 of ladder 11. The over center latch 30 has a latch mounting base 58 that receives fasteners for mounting the over-center latch to the skis 16. Ears 60 protrude from the mounting base 58. A locking handle 62 is pivotally mounted to ears 60 by fasteners 64. In the illustrated embodiment, the locking handle 62 includes an ergonomic grip.

The latch hook 66 is pivotally mounted to the handle 62 by fasteners 68. The handle 62 has legs 72 that have a locking tab 74. The legs 72 move with respect to the L-shaped side members 76 that form the handle 62. The handle grip 73 are spring loaded to move the legs 72 with respect to the L-shaped side members 76. Slots 78 allow the tab 74 to slide with respect to the L-shape number 76.

The latch hook has a protrusion 80 that is engaged to lock the tab 74 to lock the latch hook 66 in place in the latched and unlatched position. A hole 75 is provided to receive a padlock for security.

The latch hook 66 is disclosed has two sections. The neck section 82 and the hook section 84. Both neck 82 and hook section 84 have multiple holes 85 to adjust the hook section height to accommodate ladders 11 of various heights. In the disclosed embodiment, the latch hook 66, specifically the hook section 84, is vinyl dipped to aid in preventing damage to the ladder 11 at contact points.

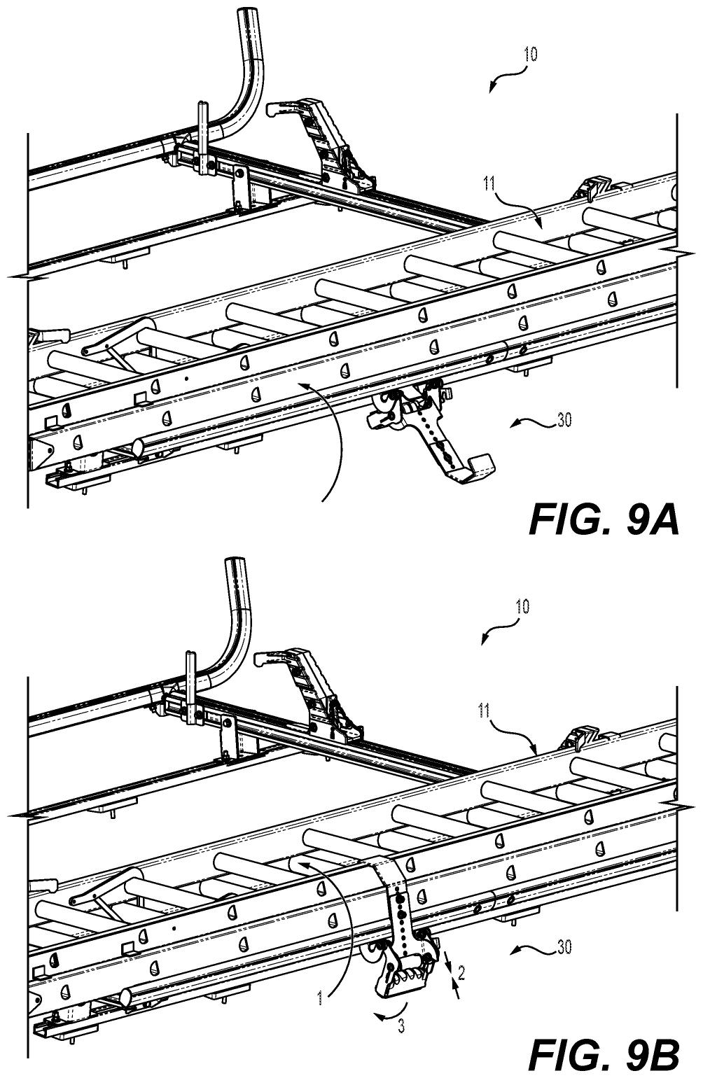

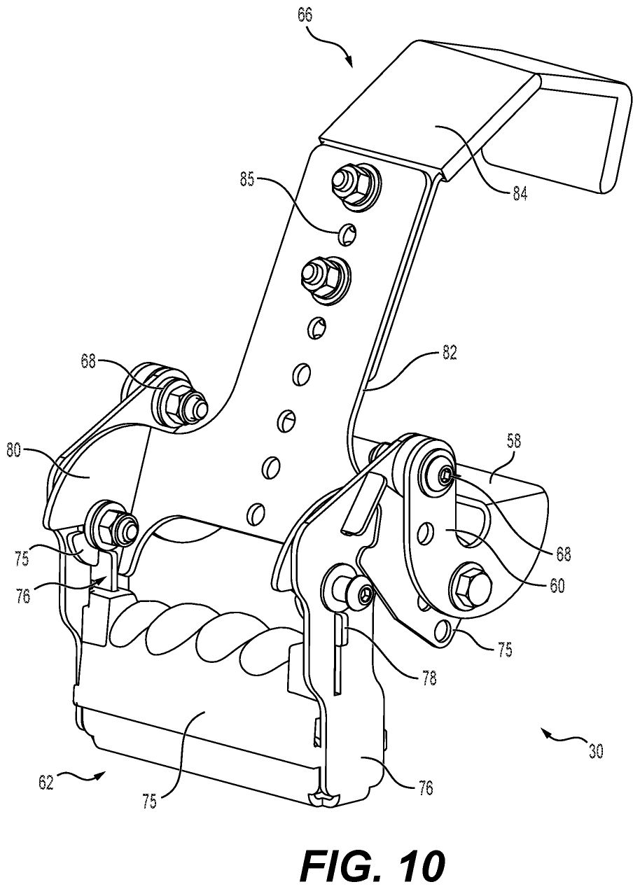

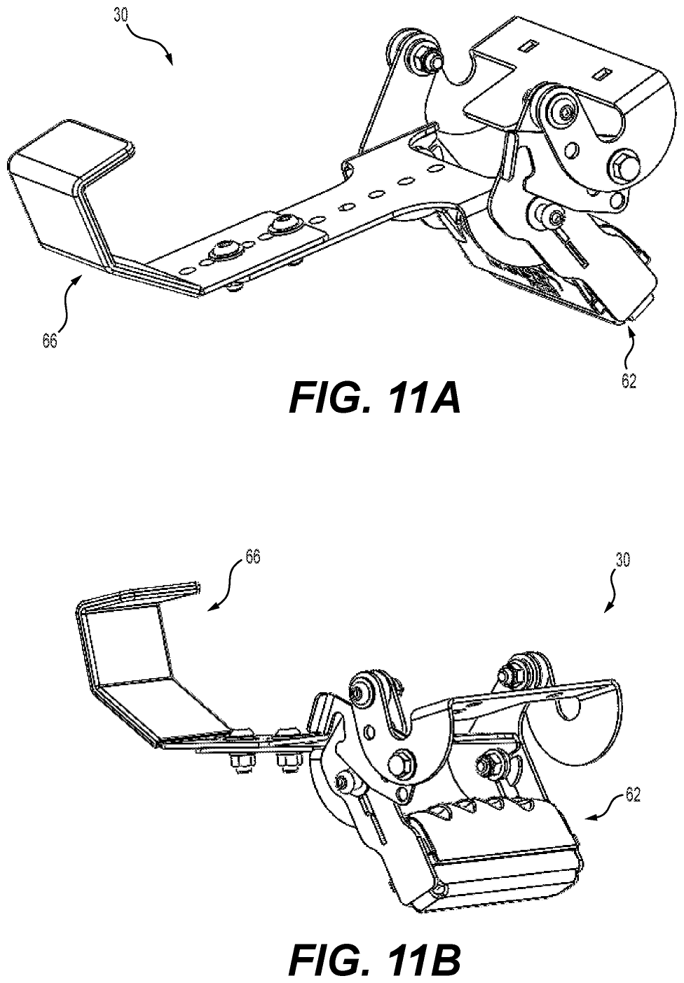

As is illustrated in FIGS. 9A and 9B, the over-center latch 30 is configured to be positioned out of the path of movement of the ladder 11 when in an open position (FIGS. 11A, 11B) in order to reduce difficulty in installing the ladder 11 on the rack 10 or for removing the ladder 11 from the rack 10. Moving the over-center latch 30 to a closed position (FIGS. 8 and 10) then puts the over-center latch 30 into a position which aids in preventing movement of the ladder 11.

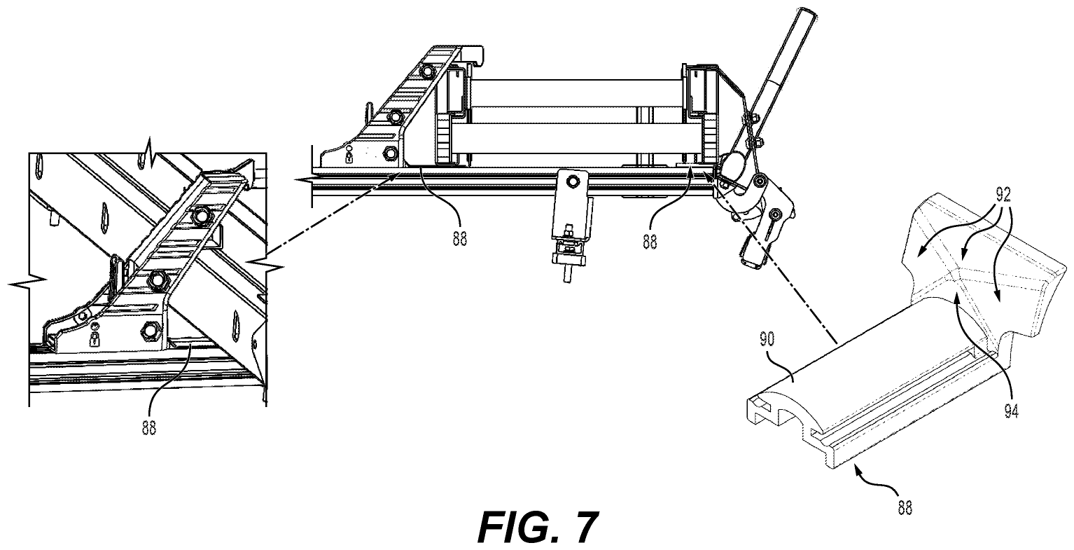

With reference to FIG. 7, ladder rests 88 are provided. The ladder rests 88 have a rounded surface 90, preferably plastic to protect the ladder 11 from damage. The angled surfaces 92 of each of the ladder rests 88 facilitate the positioning of the ladder side rails 15 under the retention hooks 20. The flat vertical surface 94 of the ladder rests 88 helps to hold the ladder securely. The flat vertical surface 94 of the ladder rests 88 helps to hold the ladder securely.

The skis 16 are angled with respect to the cross members 14 to facilitate the ergonomic loading and unloading of the ladder 11. At least some portions, depending on the particular embodiment, of the skis 16 are covered by a plastic tape, or other at least partially compressible material, in order to aid in preventing damage to the ladder 11 when installing or removing the ladder 11 from the rack 10.

Modifications and improvements to the above-described embodiments of the present technology may become apparent to those skilled in the art. The foregoing description is intended to be exemplary rather than limiting. The scope of the present technology is therefore intended to be limited solely by the scope of the appended claims.

What is claimed is:

1. A ladder rack assembly for connecting at least one ladder to a vehicle, the ladder rack assembly comprising:
a frame configured to connect to a roof of the vehicle;
a first retention hook connected to a first laterally extending frame portion;
a second retention hook connected to a second laterally extending frame portion; and
an over-center latch connected to a longitudinally extending frame portion,
the first retention hook, the second retention hook, and the over-center latch being arranged to secure the at least one ladder to the vehicle.

2. The ladder rack assembly of claim 1, wherein, when the at least one ladder is installed on the ladder rack assembly:
the first retention hook is disposed laterally inward of the at least one ladder, an upper portion of the first retention hook extending from an exterior of the at least one ladder and over an inward-arranged side of the at least one ladder;
the second retention hook is disposed laterally inward of the at least one ladder, an upper portion of the second retention hook extending from the exterior of the at least one ladder and over the inward-arranged side of the at least one ladder; and
the over-center latch is disposed laterally outward of the at least one ladder, an upper portion of the over-center latch extending from the exterior of the at least one ladder and over an outward-arranged side of the at least one ladder.

3. The ladder rack assembly of claim 1, wherein the frame includes:
a first ski configured to connect to a first side portion of the roof;
a second ski configured to connect to a second side portion of the roof, the second ski being arranged parallel to the first ski;
a first cross-member connected to a first end portion of the first ski and a first end portion of the second ski; and
a second cross-member connected to a second end portion of the first ski and a second end portion of the second ski, the first end portions of the first ski and the second ski being disposed at ends opposite to the first end portions of the first ski and the second ski, the second cross-member being arranged parallel to the first cross-member,
the first and second cross-members being arranged orthogonal to the first and second skis.

4. The ladder rack assembly of claim 3, wherein:
the first laterally extending frame portion includes the first cross-member;
the first retention hook is connected to the first cross-member;
the second laterally extending frame portion includes the second cross-member;
the second retention hook is connected to the second cross-member;
the longitudinally extending frame portion includes the first ski; and
the over-center latch is connected to the first ski.

5. The ladder rack assembly of claim 1, wherein:
the over-center latch is pivotally connected to the frame; and
in an open position, at least a majority of the over-center latch is disposed below the frame.

6. The ladder rack assembly of claim 1, wherein:
the over-center latch is selectively positionable along a longitudinal direction.

7. The ladder rack assembly of claim 1, wherein:
the first retention hook and the second retention hook are slidably connected to the frame; and
the first retention hook and the second retention hook are selectively positionable along a lateral direction.

8. The ladder rack assembly of claim 7, wherein at least one of the first retention hook and the second retention hook includes a quick release fastener for selectively securing and selectively moving the at least one of the first retention hook and the second retention hook.

9. The ladder rack assembly of claim 1, further comprising at least one ladder stopper connected to the frame, the ladder stopper being configured to abut the at least one ladder when installed on the ladder rack assembly.

10. The ladder rack assembly of claim 4, where the at least one ladder is a first ladder and the ladder rack assembly is configured to connect the first ladder and a second ladder to the vehicle, wherein:
the over-center latch is a first over-center latch, and
the first retention hook, the second retention hook, and the over-center latch are arranged to secure the first ladder to the vehicle; and
the ladder rack assembly further comprising:
a third retention hook connected to the first cross-member;
a fourth retention hook connected to the second cross-member; and
a second over-center latch connected to the second ski,
the third retention hook, the fourth retention hook, and the second over-center latch being arranged to secure the second ladder to the vehicle.

11. The ladder rack assembly of claim 10, further comprising:
a first ladder stopper connected to the frame, the first ladder stopper being configured to abut the first ladder when installed on the ladder rack assembly; and
a second ladder stopper connected to the frame, the second ladder stopper being configured to abut the second ladder when installed on the ladder rack assembly.

12. The ladder rack assembly of claim 3, wherein:
the first ski is formed from two first selectively connected elongate members; and
the second ski is formed from two second selectively connected elongate members.
